(19) United States
(12) Patent Application Publication
(10) Pub. No.: US 2026/0194390 A1
(43) Pub. Date: Jul. 9, 2026

(54) OPTICAL ELEMENT, ARITHMETIC METHOD, AND ELECTRONIC DEVICE

(71) Applicant: SONY SEMICONDUCTOR SOLUTIONS CORPORATION, KANAGAWA (JP)

(72) Inventors: KATSUHIKO HANZAWA, KANAGAWA (JP); HIDEKI NAGANUMA, KANAGAWA (JP); MASAKI SAKAKIBARA, KANAGAWA (JP)

(21) Appl. No.: 19/131,000

(22) PCT Filed: Oct. 26, 2023
(86) PCT No.: PCT/JP2023/038777

§ 371 Date: May 19, 2025

(30) Foreign Application Priority Data
Nov. 24, 2022 (JP) 2022-187181

(51) Int. Cl. G01J 1/44; G06E 1/00; H04N 25/771; H04N 25/78

(52) U.S. Cl. CPC G01J 1/44; G06E 1/00; H04N 25/771; H04N 25/78; G01J 2001/446; G01J 2001/448

(57) ABSTRACT

The present disclosure provides an optical element, an arithmetic method, and an electronic device capable of performing analog arithmetic operation using capacitance and enabling further reduction in size. According to the present disclosure, a photodetection element is provided, which includes: a pixel including a photoelectric conversion element that photoelectrically converts incident light; a readout circuit having a first capacitance capable of maintaining a potential according to a charge generated by the photoelectric conversion; and an arithmetic circuit capable of changing the number of times of readout of the potential of the first capacitance according to an arithmetic coefficient, in which the arithmetic circuit reads a reset potential of the first capacitance the number of times, and reads a photoelectric conversion potential of the first capacitance according to the charge generated by the photoelectric conversion the number of times.

### TECHNICAL FIELD

The present disclosure relates to an optical element, an arithmetic method, and an electronic device.

### BACKGROUND ART

In recent years, to implement advanced tasks such as image recognition and object position detection, a processor that has a deep neural network (DNN) implemented on hardware and performs an operation has been put into practical use. However, since a neural network (DNN) has many memory accesses, power efficiency is deteriorated in a Neumann-type arithmetic unit (for example, DSP). For this reason, an analog operation using capacitance has been studied.

### CITATION LIST

### Patent Document

Patent Document 1: Japanese Patent Application Laid-Open No. 2020-113809
Patent Document 2: Japanese Patent Application No. 2018-543822

### SUMMARY OF THE INVENTION

### Problems to be Solved by the Invention

However, in an optical element capable of performing analog operation using capacitance, there is a possibility that the number of transistors for control increases and the size increases. Therefore, the present disclosure provides an optical element, an arithmetic method, and an electronic device capable of performing analog operation using capacitance and enabling further reduction in size.

### Solutions to Problems

To solve the above-described problem, according to the present disclosure,
an optical element is provided, which includes:
a pixel including a photoelectric conversion element that photoelectrically converts incident light;
a readout circuit having a first capacitance capable of maintaining a potential according to a charge generated by the photoelectric conversion; and
an arithmetic circuit capable of changing the number of times of readout of the potential of the first capacitance according to an arithmetic coefficient, in which
the arithmetic circuit reads a reset potential of the first capacitance the number of times, and reads a photoelectric conversion potential of the first capacitance according to the charge generated by the photoelectric conversion the number of times.

A second capacitance connected to a first signal line may be further included, and
the arithmetic circuit may include
a first switching element having one end connected to the first capacitance,
a third capacitance connected to another end of the first switching element, and
a second switching element having one end connected to the third capacitance and another end connected to the first signal line.

The arithmetic circuit may repeat
driving of bringing the first switching element into a conductive state for a predetermined period, and then bringing the first switching element into a non-conductive state, and bringing the second switching element into a conductive state for a predetermined period the number of times according to the arithmetic coefficient.

The number of times may include zero, and
the arithmetic circuit may have a first mode of repeating the driving with respect to the reset potential according to the arithmetic coefficient.

The arithmetic circuit may have a second mode of repeating the driving with respect to the photoelectric conversion potential according to the arithmetic coefficient.

An analog-to-digital converter connected to the first signal line may be further included.

The analog-to-digital converter may generate a digital image signal according to the arithmetic coefficient on the basis of a first numerical value according to a potential of the first signal line in the first mode and a second numerical value according to a potential of the first signal line in the second mode.

A plurality of the readout circuits may be included, and
the first capacitance of each of the plurality of readout circuits may be connected to the one end of the first switching element.

Each of the readout circuits may include the corresponding pixel, and
the pixel may further include
a transfer transistor having one end connected to a cathode of the photoelectric conversion element and another end connected to the first capacitance of the corresponding readout circuit.

Each of the readout circuits may include a plurality of the corresponding pixels.

A control circuit may be further included, and
the pixel may further include
a transfer transistor having a gate connected to a control line of the control circuit, one end connected to a cathode of the photoelectric conversion element, and another end connected to the first capacitance of the corresponding readout circuit, and
the readout circuit may include
a reset transistor having a gate connected to the control line of the control circuit, one end connected to the first capacitance, and another end connected to a predetermined potential, and
an amplification transistor having a gate connected to the first capacitance and another end connected to one end of the first switching element.

The control circuit may bring the reset transistor into a conductive state for a predetermined time and then bring the reset transistor into a non-conductive state, and bring the transfer transistor into a non-conductive state to generate the reset potential.

The control circuit may bring the transfer transistor into a conductive state for a predetermined time and bring the reset transistor into a conductive state for a predetermined time, then bring the transfer transistor and the reset transistor into a non-conductive state, and bring the transfer transistor into a conductive state for a predetermined time after a lapse of a predetermined time to generate the photoelectric conversion potential.

A second capacitance connected to a second signal line may be further included,
the second signal line may be a signal line arranged in a first direction or a signal line arranged in a second direction different from the first direction, and
the arithmetic circuit may further include
a third switching element having one end connected to the second capacitance and another end connected to the second signal line.

The third capacitance may have at least one of an interwiring capacitance (metal-oxide-metal (MOM)), a metal/insulating film/metal capacitance (metal-insulator-metal (MIM)), or an element capacitance (MOS-cap).

A fourth switching element may be further included, and the second switching element may have another end connected to the first signal line via the fourth switching element.

Control of a conductive state or a non-conductive state of the fourth switching element may be controllable by a two-dimensional XY address.

The pixel may further include
a log conversion circuit that is connected to the photoelectric conversion element and nonlinearly converts the potential according to the photoelectric conversion of the photoelectric conversion element, and
the photoelectric conversion potential of the first capacitance may be a potential via the log conversion circuit.

To solve the above-described problem, according to the present disclosure, an arithmetic method for an optical element is provided, the optical element including
a pixel including a photoelectric conversion element that photoelectrically converts incident light,
a readout circuit having a first capacitance capable of maintaining a potential according to a charge generated by the photoelectric conversion,
an arithmetic circuit capable of performing an arithmetic operation according to a number of times of readout of the potential of the first capacitance, and
a second capacitance connected to a first signal line, and
the arithmetic circuit including
a first switching element having one end connected to the first capacitance,
a third capacitance connected to another end of the first switching element, and
a second switching element having one end connected to the third capacitance and another end connected to the first signal line,
the arithmetic method including:
repeating, according to an arithmetic coefficient, driving of bringing the first switching element into a conductive state for a predetermined period and then bringing the first switching element into a non-conductive state, and bringing the second switching element into a conductive state for a predetermined period, with respect to each of a reset potential of the first capacitance and a photoelectric conversion potential of the first capacitance according to the charge generated by the photoelectric conversion.

To solve the above-described problem, according to the present disclosure,
there is provided an electronic device including:
an optical element, and
an optical system that condenses incident light on the pixel.

Aspects of the present disclosure are not limited to the above-described individual embodiments, but include various modifications that can be conceived by those skilled in the art, and the effects of the present disclosure are not limited to the above-described contents. That is, various additions, modifications, and partial deletions are possible without departing from the conceptual idea and spirit of the present disclosure derived from the matters defined in the claims and equivalents thereof.

### BRIEF DESCRIPTION OF DRAWINGS

FIG. 1 is a block diagram illustrating a configuration example of an imaging device according to an embodiment of the present technology.

FIG. 2 is a block diagram illustrating a schematic configuration of a photodetection element according to the present disclosure.

FIG. 3 is a block diagram illustrating a configuration example of a readout circuit.

FIG. 4A is a circuit diagram illustrating a configuration example of a pixel circuit.

FIG. 4B is a diagram in which a capacitance of an arithmetic circuit includes a variable capacitance.

FIG. 5 is a diagram illustrating a layout of the pixel circuit.

FIG. 6 is a diagram illustrating a chip configuration example of a solid-state imaging element.

FIG. 7 is a timing chart illustrating an example of an operation of the photodetection element.

FIG. 8 is a circuit diagram illustrating a configuration example of a pixel circuit according to a second embodiment.

FIG. 9 is a diagram illustrating a layout of the pixel circuit.

FIG. 10A is a diagram illustrating a vertical signal line and an example of connection to the vertical signal line.

FIG. 10B is a diagram illustrating the vertical signal line and an example of connection to the vertical signal line in a case of being arranged in a horizontal direction.

FIG. 11 is a time chart illustrating an operation example of the upper pixel circuit illustrated in FIG. 10A.

FIG. 12 is a time chart illustrating an operation example of the lower pixel circuit illustrated in FIG. 10A.

FIG. 13 is a circuit diagram illustrating a configuration example of a pixel circuit according to Modification 1 of the second embodiment.

FIG. 14A is a circuit diagram illustrating a configuration example of a pixel circuit according to Modification 2 of the second embodiment.

FIG. 14B is a diagram in which an arrangement example of FIG. 14A is changed from a vertical direction to a horizontal direction.

FIG. 15 is a circuit diagram illustrating a configuration example of a pixel circuit according to a third embodiment.

FIG. 16 is a diagram illustrating an example in which the pixel circuits according to the third embodiment are two-dimensionally arranged.

FIG. 17 is a circuit diagram illustrating a configuration example of a pixel circuit according to a fourth embodiment.

FIG. 18 is a circuit diagram illustrating a configuration example of a pixel circuit according to a fifth embodiment.

FIG. 19 is a circuit diagram illustrating a configuration example of a pixel circuit according to a sixth embodiment.

FIG. 20 is a circuit diagram illustrating a configuration example of a pixel circuit according to a seventh embodiment.

FIG. 21 is a circuit diagram illustrating a configuration example of a pixel circuit according to an eighth embodiment.

FIG. 22 is a diagram illustrating a configuration example of a readout circuit according to a ninth embodiment.

FIG. 23 is a diagram illustrating a configuration example of a readout circuit according to a tenth embodiment.

### MODE FOR CARRYING OUT THE INVENTION

Hereinafter, embodiments of an optical element, an arithmetic method, and an electronic device will be described with reference to the drawings. Hereinafter, principal components of the optical element, the arithmetic method, and the electronic device will be mainly described, but the optical element, the arithmetic method, and the electronic device may have components and functions that are not illustrated or described. The following description does not exclude components and functions that are not illustrated or described.

### Configuration Example of Imaging Device

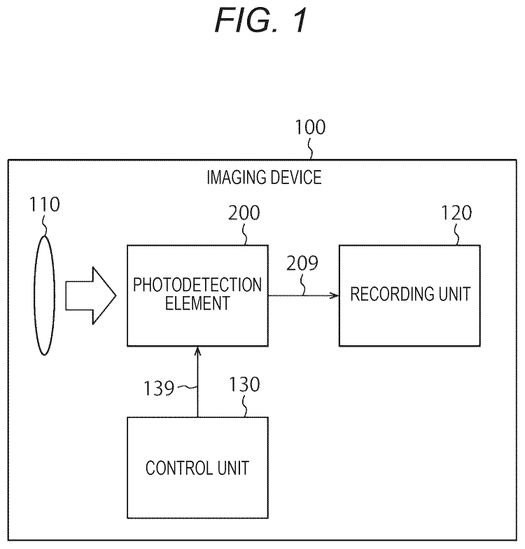

FIG. 1 is a block diagram illustrating a configuration example of an imaging device 100 according to an embodiment of the present technology. The imaging device 100 includes an imaging lens 110, a photodetection element 200, a recording unit 120, and a control unit 130. As the imaging device 100, an electronic device such as a camera mounted on a wearable device or an in-vehicle camera is assumed. Note that the imaging lens 110 according to the present embodiment corresponds to an optical system, and the imaging device 100 corresponds to an electronic device.

The imaging lens 110 condenses incident light on the photodetection element 200. The photodetection element 200 has a plurality of pixels. That is, the plurality of pixels is arranged in a matrix on a light receiving surface of the photodetection element 200, and an optical image via the imaging lens 110 is detected. Note that, in the present embodiment, a predetermined region having at least one photoelectric conversion element may be referred to as a pixel. Furthermore, in the present embodiment, a configuration including one photoelectric conversion element and at least one electronic circuit or electronic element (for example, a transistor) connected to the photoelectric conversion element may be referred to as a pixel circuit.

Each of the pixel circuits according to the present embodiment can generate an image signal by analog addition based on signal charges of the pixel. The photodetection element 200 constitutes an image on the basis of the image signal output from each of the pixel circuits. This image corresponds to an image after a convolution operation based on, for example, a signal charge of each pixel. Furthermore, the photodetection element 200 can execute predetermined signal processing such as image recognition processing for the image and output processed data to the recording unit 120 via a signal line 209.

The recording unit 120 records the data from the photodetection element 200. The control unit 130 controls the photodetection element 200 via a signal line 139 to capture image data.

### Configuration Example of Photodetection Element

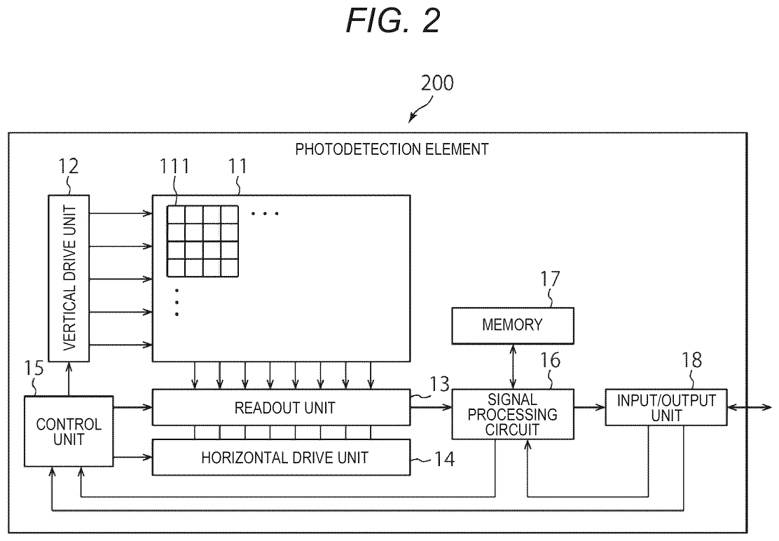

FIG. 2 is a block diagram illustrating a schematic configuration of the photodetection element according to the present disclosure.

The photodetection element 200 in FIG. 2 includes a pixel array unit 11 in which a plurality of pixels 111 is arranged in a matrix and a peripheral circuit unit around the pixel array unit. The peripheral circuit unit includes a vertical drive unit 12, a readout unit 13, a horizontal drive unit 14, a control unit 15, a signal processing circuit 16, a memory 17, an input/output unit 18, and the like.

Each of the pixels 111 two-dimensionally arranged in the pixel array unit 11 includes the photoelectric conversion element. The photoelectric conversion element is, for example, a photodiode. Furthermore, in the pixel array unit 11, a plurality of pixel transistors and the like used to control photoelectric conversion by the photodiode are configured.

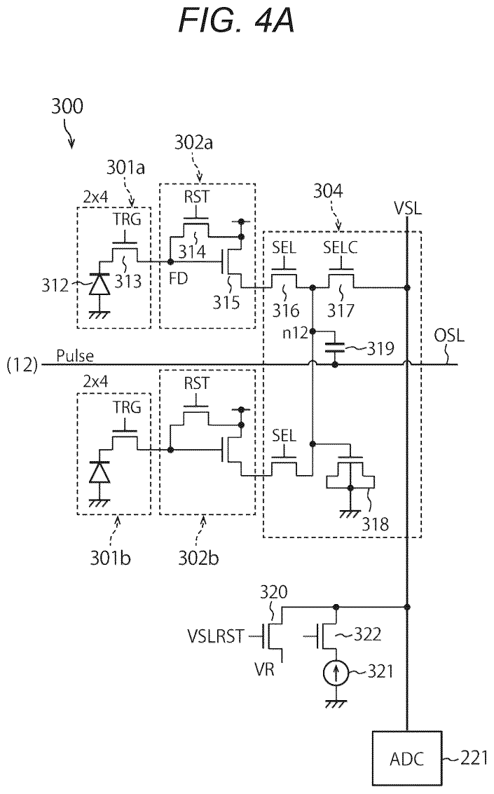

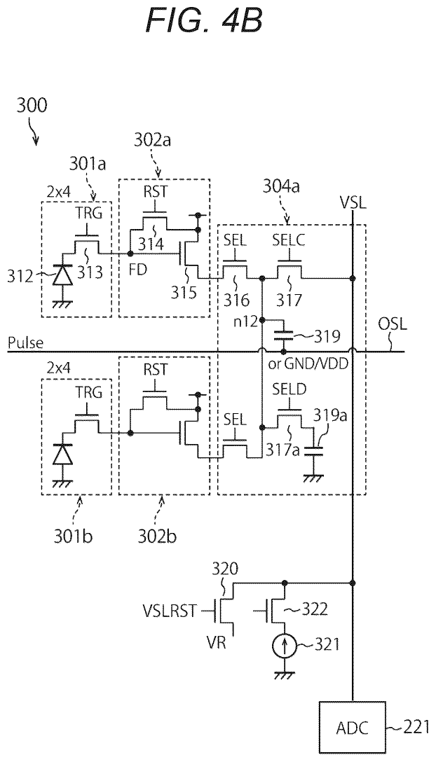

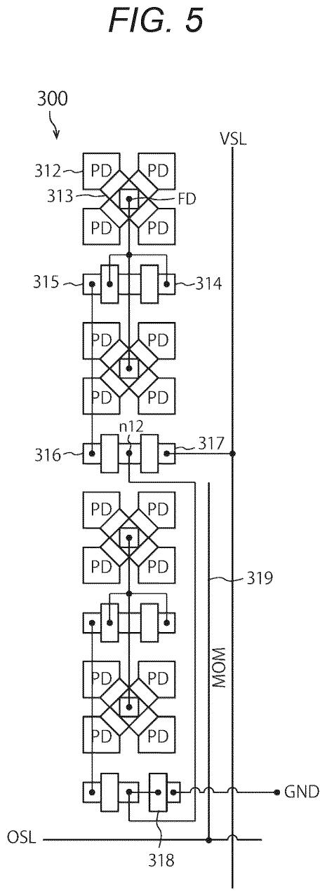

The plurality of pixel transistors includes, for example, MOS transistors such as a transfer transistor, an amplification transistor, a selection transistor, and a reset transistor. For example, red, green, and blue color filters are arranged in a Bayer array in each pixel 111 of the pixel array unit 11, and each pixel outputs a digital image signal of any one of red, green, or blue. Note that the array of the color filters according to the present embodiment is a Bayer array, but is not limited thereto. For example, quad coding (2×2), a combination pattern of red, green, blue, and white (RGBW), or the like, other than the Bayer array, may be used. Note that the circuit configuration example of the pixel will be described below with reference to FIGS. 4A, 4B, 5, and the like.

The vertical drive unit 12 includes, for example, a shift register, and drives the pixels for each row by supplying a drive pulse to each pixel of the pixel array unit 11 via pixel drive wiring (control line). Note that, in the present embodiment, it is also possible to generate the digital image signal by analog addition based on the signal charges of a plurality of the pixels. In such a case, the vertical drive unit 12 can drive the pixels in units of a plurality of rows. For example, the vertical drive unit 12 selectively and sequentially scans the pixels of the pixel array unit 11 in units of a plurality of rows in a vertical direction, and supplies, to the readout unit 13, the digital image signal based on the signal charges generated according to an amount of incident light in the photodiodes of the pixels through a vertical signal line commonly provided in units of columns.

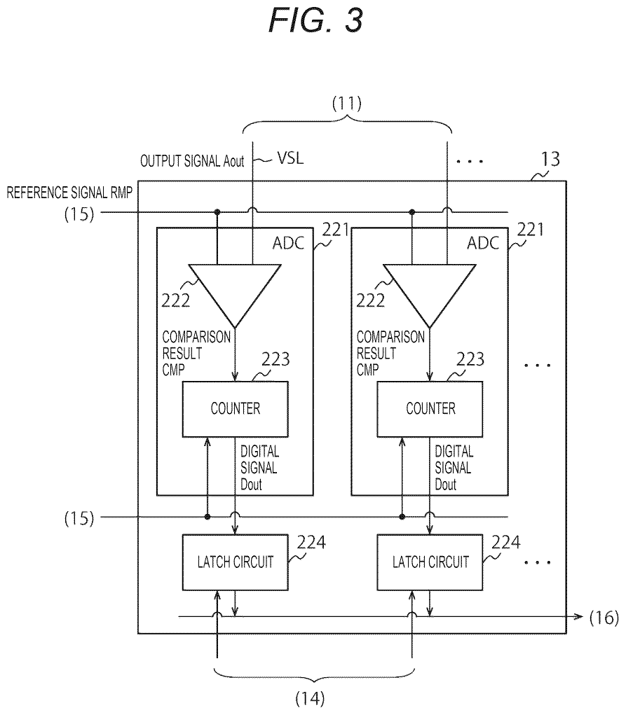

The readout unit 13 performs correlated double sampling (CDS) processing for removing fixed pattern noise peculiar to a pixel and AD conversion processing for the digital image signal output from the pixel array unit 11. Note that details of the readout unit 13 will be described below with reference to FIG. 3.

The horizontal drive unit 14 includes, for example, a shift register, and sequentially outputs a horizontal scanning pulse to sequentially output the digital image signal held in the readout unit 13 to the signal processing circuit 16.

The control unit 15 receives a clock signal and data for instructing an operation mode and the like input from an outside, and controls operation of the entire photodetection element 200. For example, the control unit 15 generates a vertical synchronization signal, a horizontal synchronization signal, and the like on the basis of the input clock signal, and supplies the generated signals to the vertical drive unit 12, the readout unit 13, the horizontal drive unit 14, and the like. Furthermore, the control unit 15 includes a DAC circuit. The DAC circuit generates a predetermined reference signal and supplies the generated reference signal to the readout unit 13. As the reference signal, for example, a sawtooth-shaped ramp (RMP) signal is used. Note that the vertical drive unit 12 according to the present embodiment corresponds to a control circuit.

The signal processing circuit 16 executes various types of digital signal processing such as black level adjustment processing, column variation correction processing, and demosaic processing for the digital image signal supp from the readout unit 13 as necessary, and supplies the digital image signal to the input/output unit 18. There is also a case where the signal processing circuit 16 performs only buffering and outputting depending on the operation mode. The memory 17 stores data such as parameters required for the signal processing performed by the signal processing circuit 16. Furthermore, the memory 17 also includes, for example, a frame memory for storing the image signal in processing such as demosaic processing. The signal processing circuit 16 stores parameters and the like input from an external image processing device via the input/output unit 18 in the memory 17. Furthermore, the signal processing circuit 16 can appropriately select and execute the signal processing on the basis of an instruction from an external image processing device.

The input/output unit 18 outputs the image signals sequentially input from the signal processing circuit 16 to an external image processing device, for example, a subsequent image signal processor (ISP). Furthermore, the input/output unit 18 supplies the signals and parameters input from the external image processing device to the signal processing circuit 16 and the control unit 15.

FIG. 3 is a block diagram illustrating a configuration example of the readout circuit 230. In the readout circuit 230, an ADC 221 and a latch circuit 224 are arranged for each vertical signal line VSL.

The ADC 221 converts an analog output signal Aout from the corresponding column into a digital signal Dout. This AD conversion is also called readout of the analog signal. The ADC 221 is, for example, a single-slope ADC, and includes a comparator 222 and a counter 223.

The comparator 222 compares a reference signal RMP from a DAC (not illustrated) with the output signal Aout. The comparator 222 supplies a comparison result CMP to the counter 223. The counter 223 counts a count value over a period until the comparison result CMP is inverted. The counter 223 outputs a digital signal Dout indicating the count value to the latch circuit 224. Furthermore, the counter 223 can perform either up counting or down counting, and can switch from one of the up counting and the down counting to the other under the control of the control unit 15. Furthermore, the comparator 222 can perform AutoZero based on a reset signal and perform the CDS.

The latch circuit 224 holds the digital signal Dout. The digital signal Dout according to the present embodiment corresponds to a so-called P-phase digital signal Dp and a so-called D-phase digital signal Dd. These latch circuits 224 output signals under the control of the horizontal drive unit 14 (see FIG. 2). That is, the latch circuit 224 calculates a difference between the digital signals Dp and Dd and outputs the difference to a signal processing circuit 31 (see FIG. 1) under the control of the horizontal drive unit 14 (see FIG. 2).

Note that, in the present embodiment, the ADC 221 is arranged for each vertical signal line VSL, but the embodiment is not limited thereto. For example, a method in which one ADC 221 corresponds to all columns may be adopted. Furthermore, as the ADC 221, for example, a single-slope ADC, a successive approximation register analog to digital converter (SARADC), a delta sigma ADC, a pipeline ADC, a double integration ADC, a flash ADC, or the like can be applied. In a case where the number of vertical signal lines VSL is one, one-input ADC is preferable. Meanwhile, in a case where plus and minus are expressed by two ADCs, two one-input ADCs may be prepared and a difference may be obtained in a digital domain from ADC results, or a difference may be subject to ADC using a two-input ADC. For example, in the case of a two-input ADC, for example, a SAR-ADC can be used. Furthermore, in the case of a two-input ADC, an operation such as ReLU may be further performed. The ReLU is a function to output zero when a minus signal is obtained by adding a pulse signal and a minus signal. This function can be implemented by adjusting a dynamic range of the ADC.

FIG. 4A is a circuit diagram illustrating a configuration example of a pixel circuit 300. As illustrated in FIG. 4A, the pixel circuit 300 according to the present embodiment includes a plurality of photoelectric conversion circuits 301a and 301b, a plurality of readout circuits 302a and 302b, and an arithmetic circuit 304. FIG. 4A further illustrates a VSL reset transistor 320, a current source 321, and a current source connection transistor 322. Furthermore, the vertical signal line VSL has a parasitic capacitance Cvsl. Note that the two readout circuits 302a and 302b and the corresponding photoelectric conversion circuits 301a and 301b are connected to the arithmetic circuit 304 according to the present embodiment, but the number is not limited to two. For example, one, two, four, or eight readout circuits and corresponding pixels may be connected.

The photoelectric conversion circuit 301a includes eight photoelectric conversion elements 312 and eight transfer transistors 313. The photoelectric conversion element 312 and the corresponding transfer transistor 313 constitute the pixel 111 (see FIG. 2). Since the photoelectric conversion circuit 301b has a configuration equivalent to the photoelectric conversion circuit 301a, description thereof is omitted.

Furthermore, the readout circuit 302a includes a reset transistor 314, a floating diffusion (floating capacitance) FD, and an amplification transistor 315. Since the readout circuit 302b has a configuration equivalent to the readout circuit 302a, description thereof is omitted. As described above, for example, an n-channel MOS (nMOS) transistor is used as the transistor of the pixel circuit 300.

The photoelectric conversion element 312 is, for example, a photodiode, and has an anode connected to a ground and a cathode connected to one end of the transfer transistor 313. The photoelectric conversion element 312 converts the incident light on the pixel 111 (see FIG. 2) into a charge.

The other end of the transfer transistor 313 is connected to the floating diffusion FD. The control line of the vertical drive unit 12 is connected to a gate, and a signal TRG is supplied thereto. The transfer transistor 313 is in a conductive state when the signal TRG is at a high level, and is in a non-conductive state when the signal TRG is at a low level. When the transfer transistor 313 is in the conductive state, a potential of the floating diffusion FD is a potential of the charge accumulated in the photoelectric conversion element 312. Note that the floating diffusion FD according to the present embodiment is, for example, a floating capacitance and corresponds to a first capacitance.

In the present embodiment, 2×4 pixels 111 are connected in parallel to the floating diffusion FD. As a result, the charges accumulated by the 2×4 pixels 111 can be simultaneously read as the image signal via the floating diffusion FD. Note that the image signal can be individually read from the pixel 111, and in this case, a normal captured image can be obtained. Note that, in the present embodiment, the 2×4 pixels 111 form one combination, but the present embodiment is not limited thereto. For example, 1, 2, 4, 16, or 32 pixels 111 may be connected to one floating diffusion FD.

One end of the reset transistor 314 is connected to the floating diffusion FD, and the other end is connected to a power line of a voltage VDD. The control line of the vertical drive unit 12 is connected to a gate of the reset transistor 314, and a signal RST is supplied thereto. The reset transistor 314 is in the conductive state when the signal RST is at the high level, and is in the non-conductive state when the signal RST is at the low level. When the reset transistor 314 is in the conductive state, the accumulated charge in the floating diffusion FD is discharged, and the potential of the floating diffusion FD can be set to a reset potential.

One end of the amplification transistor 315 is connected to one end of the selection transistor 316, and the other end is connected to the power line of the voltage VDD. A gate is connected to the floating diffusion FD. The amplification transistor 315 amplifies the potential of the floating diffusion FD.

The other end of the selection transistor 316 is connected to a node n12. The control line of the vertical drive unit 12 is connected to a gate of the selection transistor 316, and a signal SEL is supplied thereto. The selection transistor 316 is in the conductive state when the signal SEL is at the high level, and is in a non-conductive state when the signal SEL is at the low level. When the selection transistor 316 is in the conductive state, the potential amplified by the amplification transistor 315 is applied to the node n12. Note that the selection transistor 316 according to the present embodiment corresponds to a first switching element.

One end of a connection transistor 317 is connected to the node n12, and the other end is connected to the vertical signal line VSL. The control line of the vertical drive unit 12 is connected to a gate of the connection transistor 317, and a signal SELC is supplied thereto. The connection transistor 317 is in the conductive state when the signal SELC is at the high level, and is in the non-conductive state when the signal SELC is at the low level. Note that the selection connection transistor 317 according to the present embodiment corresponds to a second switching element.

A capacitance element 318 (MOS-cap) on the side of the photoelectric conversion circuit 301b is an element equivalent to the connection transistor 317, and for example, a drain thereof is connected to the ground and a gate is connected to the node n12. The capacitance element 318 can be used to increase the capacitance of a capacitance 319 to be described below. Furthermore, by arranging the capacitance element 318, it is possible to balance arrangement of the transistors corresponding to the photoelectric conversion circuit 301a and arrangement of the transistors corresponding to the photoelectric conversion circuit 301b. For example, by balancing the arrangement, it is possible to harmonize the parasitic capacitance corresponding to the photoelectric conversion circuit 301a and the parasitic capacitance corresponding to the photoelectric conversion circuit 301b, and to suppress occurrence of a unique potential distribution.

One end of a capacitance 319 is connected to the node n12, and the other end is connected to a horizontal signal line OSL. An offset potential can be supplied from the vertical drive unit 12 to the horizontal signal line OSL.

In the present embodiment, a capacitance obtained by combining the capacitance element 318 and the capacitance 319 is referred to as CSC. When the above-described connection transistor 317 is in the conductive state, the potential of the node n12 has the same value at one end of the capacitance element 318, the capacitance 319, and a parasitic capacitance Cvsel. The capacitance Cvsl is, for example, 1 pF, and the capacitance CSC is, for example, 10 fF. Note that the parasitic capacitance Cvsel according to the present embodiment corresponds to a second capacitance. Furthermore, the capacitance CSC according to the present embodiment corresponds to a third capacitance.

The VSL reset transistor 320 has one end connected to the vertical signal line VSL and the other end connected to a power terminal of a potential VR. The control line of the vertical drive unit 12 is connected to a gate of the VSL reset transistor 320, and a signal VSLRST is supplied thereto. The VSL reset transistor 320 is in the conductive state when the signal VSLRST is at the high level, and is in the non-conductive state when the signal VSLRST is at the low level.

The current source 321 is connected to the vertical signal line VSL via the current source connection transistor 322. The current source connection transistor 322 is brought into the conductive state or the non-conductive state under the control of the vertical drive unit 12.

FIG. 4B is a diagram in which the capacitance CSC of the arithmetic circuit 304a includes a variable capacitance 318a. As illustrated in FIG. 4B, a capacitance variable transistor 317a equivalent to the connection transistor 317 and a capacitance 319a are included instead of the capacitance element 318.

The capacitance variable transistor 317a has one end connected to the node n12 and the other end connected to the capacitance 319a. The control line of the vertical drive unit 12 is connected to a gate of the capacitance variable transistor 317a, and a signal SELD is supplied thereto. As a result, the capacitance of the capacitance 319a can be changed according to magnitude of an applied potential of the signal SELD. In this way, by changing the capacitance of the capacitance 319a, the capacitance CSC can be made variable.

FIG. 5 is a diagram illustrating a layout of the pixel circuit 300. As illustrated in FIG. 5, the capacitance 319 is configured by an interwiring capacitance (metal-oxide-metal (MOM)). The capacitance 319 may be configured in the same layer as the pixel 111. Alternatively, the capacitance 319 may be configured in a layer different from that of the pixel 111. Furthermore, in the present embodiment, the interwiring capacitance (metal-oxide-metal (MOM)) is used, but the present embodiment is not limited thereto. For example, metal/insulating film/metal capacitance (metal-insulator-metal (MIM)) to be described below can also be used. Alternatively, the MOS capacitance (MOS-cap) described above can also be used.

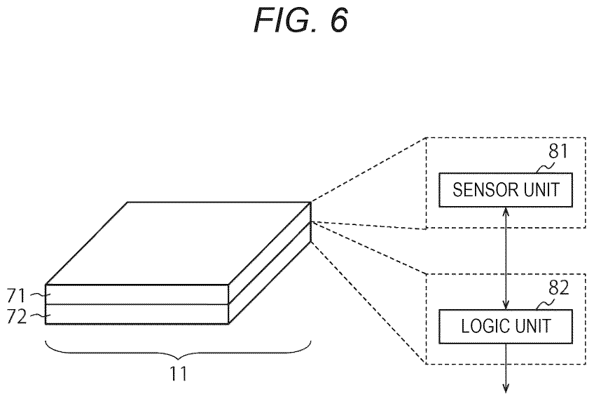

FIG. 6 is a diagram illustrating a chip configuration example of a solid-state imaging element. As illustrated in FIG. 6, the photodetection element 200 can be configured by one chip in which a sensor die 71 and a logic die 72 as a plurality of dies (substrates) are stacked. For example, a sensor unit 81 is configured in the sensor die 71, and a logic unit 82 is configured in the logic die 72.

The sensor unit 81 includes at least the pixel 111 of the pixel array unit 11. The logic unit 82 may include, for example, the reset transistor 314, the floating diffusion FD, and the amplification transistor 315. That is, the capacitance 319 (see FIG. 5) may be configured in the sensor die 71, or may be configured in the logic die 72. Furthermore, the logic unit 82 includes, for example, the vertical drive unit 12, the AD conversion unit 13, the horizontal drive unit 14, the control unit 15, the signal processing circuit 16, the memory 17, and the input/output unit 18. Note that a shared configuration of the sensor unit 81 and the logic unit 82 is not limited to this example, and any shared configuration can be used. For example, the vertical drive unit 12, the control unit 15, and the like may be arranged in the sensor unit 81 instead of the logic unit 82.

### Operation Example of Photodetection Element

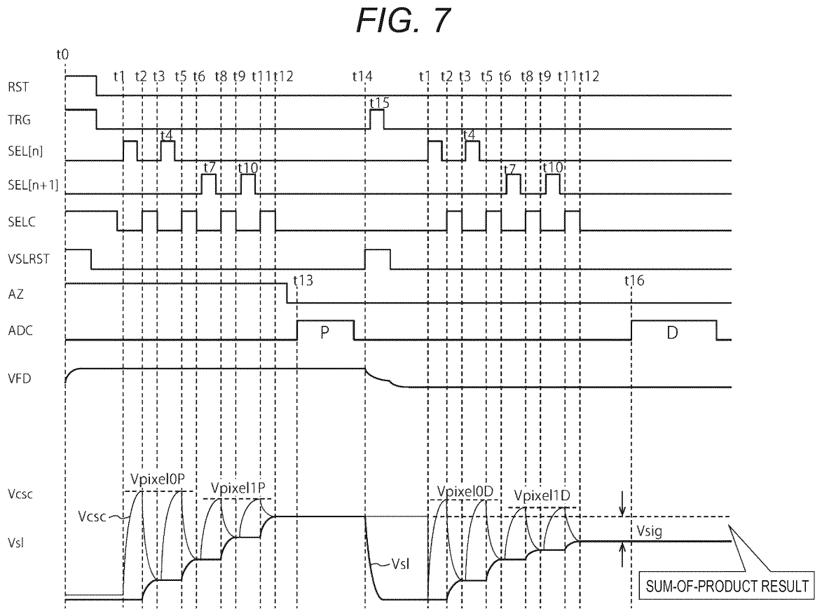

FIG. 7 is a timing chart illustrating an example of an operation of the photodetection element from exposure to analog addition according to the first embodiment of the present technology. Hereinafter, an example of the operation of the detection element will be described with reference to FIG. 7 while referring to FIG. 4.

As illustrated in FIG. 7, signals RST, TRG, SEL[n], SEL[n+1], SELC, VRLRST, AZ, ADC, VFD, Vcsc, and Vsl are illustrated from the top, and the horizontal axis indicates a time. Note that, for convenience of description, [n] is attached to the selection transistor 316 of the readout circuit 302a, and [n+1] is attached to the selection transistor 316 of the readout circuit 302b in the following description. n is a natural number.

Here, the signal AZ is a signal for causing the comparator 222 (see FIG. 3) to execute processing called auto zero processing (hereinafter, AZ processing) when the signal is at the high level. The signal ADC is a signal for causing the comparator 222 (see FIG. 3) to compare a voltage signal of the vertical signal line VSL with a voltage level of the reference signal RMP and output a signal indicating a comparison result when the signal is at the high level. Furthermore, the signal VED is the potential of the floating diffusion FD, the signal Vcsc is the potential of the node n12, and the signal Vsl is the potential of the vertical signal line. Note that, in the present embodiment, the potential after initialization of the floating diffusion FD is referred to as the reset potential. Meanwhile, the potential after the potential is applied to the floating diffusion FD based on the charge accumulated by photoelectric conversion of the photoelectric conversion element 312 is referred to as a photoelectric conversion potential.

At timing to, the vertical drive unit 12 sets the signals RST, TRG, SELC, and VRLRST to the high level over a predetermined period. The signals RST and TRG go to the high level, the transfer transistor 313 and the reset transistor 314 are brought into the conductive state, and the charges of the photoelectric conversion element 312 and the floating diffusion FD are discharged. As a result, the potential VED is initialized and set to the reset potential. Subsequently, the signals RST and TRG go to the low levels, and exposure of the photoelectric conversion element 312 is started. Furthermore, the signal AZ goes to the high level, and the AZ processing is started for the comparator 222 (see FIG. 3).

Furthermore, the signals SELC and VRLRST go to the high level, the connection transistor 317 and the VSL reset transistor 320 are brought into the conductive state, and the charges of the parasitic capacitance Cvsel and the electrostatic capacitance CSC are discharged. At this time, the vertical drive unit 12 can set an arbitrary offset potential to the signal line OSL. As a result, a base potential of the capacitance CSC can be set.

Next, the signal SEL[n] goes to the high level at timing t1, a potential VpixelmP proportional to the reset potential of the floating diffusion FD is applied to the node n12, the potential rises to a potential VpixemP, the signal SEL[n] goes to the low level, and the signal SELC goes to the high level at timing t2. While the signal SELC is at the high level, the capacitance CSC and the parasitic capacitance Cvsl are connected in parallel, and the potential Vsl of the signal line VSL varies according to the recurrence relation expression (1).

$$\begin{matrix}[ Math . 1 ] & \\ V ( n ) = ( V ( n - 1 ) \times Cvsl + VpixelmP \times CSC ) / ( Cvsl + CSC ) & ( 1 )\end{matrix}$$

Here, V(0) is the potential of an initial value of the signal line VSL. m=0 corresponds to the readout circuit 302a, and m=1 corresponds to the readout circuit 302b. That is, when the signal SELC goes to the low level at timing t3, the potential Vsl=V(1)=(V(0)×Cvsl+VpixelOP×CSC)/(Cvsl+CSC). As described above, in the expression (1), there are three parameters of the capacitance CSC, n, and a pixel addition number. The pixel addition number is determined by a model such as DNN. n is a parameter determined by an arithmetic coefficient. That is, n includes 0, and the potential Vsl increases as n increases. Since a voltage range of the signal line VSL is determined, the voltage range can be adjusted by making the capacitance CSC to be described below variable.

Next, the signal SEL[n] goes to the high level at timing t4, a potential Vpixel0 proportional to the reset potential of the floating diffusion FD is applied to the node n12, the potential rises to a potential Vpixel0P, the signal SEL[n] goes to the low level, and the signal SELC goes to the high level at timing t5. While the signal SELC is at the high level, the capacitance CSC and the parasitic capacitance Cvsl are connected in parallel, and the potential Vsl of the signal line VSL varies according to the recurrence relation expression (1). That is, when the signal SELC goes to the low level at timing t6, the potential Vsl=V(2)=(V(1)×Cvsl+Vpixel0P×CSC)/(Cvsl+CSC). In this manner, the signal SEL[n] becomes the high level the number of times according to an addition coefficient. Note that, in the present embodiment, to simplify the description, the potentials of the floating diffusions FD of the readout circuits 302a and 302b are described as equivalent values, but may be different potentials.

Next, the signal SEL[n+1] goes to the high level at timing t7, a potential Vpixel1P proportional to the floating diffusion FD of the readout circuit 302b is applied to the node n12, the potential rises to a potential Vpixe, the signal SEL[n+1] goes to the low level, and the signal SELC goes to the high level at timing t8. While the signal SELC is at the high level, the capacitance CSC and the parasitic capacitance Cvsl are connected in parallel, and the potential Vsl of the signal line VSL varies according to the recurrence relation expression (1). That is, when the signal SELC goes to the low level at timing t8, the potential Vsl=V(3)=(V(2)×Cvsl+Vpixel1P×CSC)/(Cvsl+CSC).

Next, the signal SEL[n+1] goes to the high level at timing t9, a potential Vpixel1P proportional to the floating diffusion FD of the readout circuit 302b is applied to the node n12, the potential rises to a potential Vpixe1P, the signal SEL[n+1] goes to the low level, and the signal SELC goes to the high level at timing t11. While the signal SELC is at the high level, the capacitance CSC and the parasitic capacitance Cvsl are connected in parallel, and the potential Vsl of the signal line VSL varies according to the recurrence relation expression (1). That is, when the signal SELC goes to the low level at timing t12, the potential Vsl=V(4)=(V(3)×Cvsl+Vpixel1P×CSC)/(Cvs10+CSC). In this manner, the signal SEL[n+1] becomes the high level the number of times according to the addition coefficient. In other words, the addition coefficient is adjusted according to the number of times the signal SEL[n] and the signal SEL[n+1] becomes the high level.

Next, the signal AZ goes to the low level, and the signal ADC goes to the high level at timing t13. As a result, the comparator 22 compares the potential Vsl of the signal VSL with a RAM reference potential, and the counter 223 converts the potential at the time of matching into the digital signal Dp as the P-phase potential. The digital signal Dp is stored in the latch circuit 224.

Next, at timing t14, the VRLRST is set to the high level, and the potential Vsl is reset. At timing t15 in the period in which the VRLRST is at the high level, the transfer transistor 313 goes to the high level, and the exposure time ends. During the period in which the transfer transistor 313 is at the high level, a photoelectric conversion potential VpixelmD corresponding to the photoelectric charge accumulated in the photoelectric conversion element 312 is applied to the floating diffusion FD. Thereby, the floating diffusion FD can maintain the photoelectric conversion potential VpixelmD.

Next, the VRLRST goes to the low level, and the same driving as the timing t1 to t12 is repeated according to the expression (2).

$$\begin{matrix}[ Math . 2 ] & \\ V ( n ) = ( V ( n - 1 ) \times Cvsl + VpixelmD \times CSC ) / ( Cvsl + CSC ) & ( 2 )\end{matrix}$$

Subsequently, at timing t16, the signal ADC goes to the high level. m=0 corresponds to the readout circuit 302a, and m=1 corresponds to the readout circuit 302b. As a result, the comparator 22 compares the potential Vsl of the signal VSL with the RAM reference potential, the counter 223 converts the potential at the time of matching into the digital signal Dd as the D-phase potential, and outputs the digital signal Dd to the latch circuit 224.

The latch circuit 224 calculates a difference between the digital signal Dd and the digital signal Dp and holds the difference as a digital signal Vsig. Then, the latch circuit 224 outputs the digital signal Vsig to the signal processing circuit 16 under the control of the horizontal drive unit 14.

As described above, according to the present embodiment, driving of bringing the selection transistor 316 into the conductive state for a predetermined period and then bringing the selection transistor into the non-conductive state and bringing the connection transistor 317 into the conductive state for a predetermined period at the time of analog operation is repeated the number of times according to the arithmetic coefficient. Thereby, the reset potential of the floating diffusion FD after initialization is read according to the recurrence relation expression (1) the number of times according to the arithmetic coefficient, and the potential Vsl has the same value as a value obtained by calculating a predetermined coefficient for the reset potential. Next, when the exposure time ends, the photoelectric conversion potential of the floating diffusion FD according to the photoelectrically converted charge is read according to the recurrence relation expression (2) the number of times according to the addition coefficient, and the potential Vsl has the same value as a value obtained by calculating a predetermined coefficient for the photoelectric conversion potential. As described above, at the stage of the analog signal, it is possible to generate the signal having the value obtained by calculating a predetermined coefficient for the reset potential and the signal having the value obtained by calculating a predetermined coefficient for the photoelectric conversion potential. Furthermore, therefore, it is not necessary to individually provide the arithmetic circuits 304 for the D layer and for the P layer, and it is possible to further miniaturize the pixel circuit 300.

### Second Embodiment

An imaging device 100 according to a second embodiment is different from the imaging device 100 according to the first embodiment in that positive arithmetic processing and negative arithmetic processing can be simultaneously performed. Differences from the imaging device 100 according to the first embodiment will be described below.

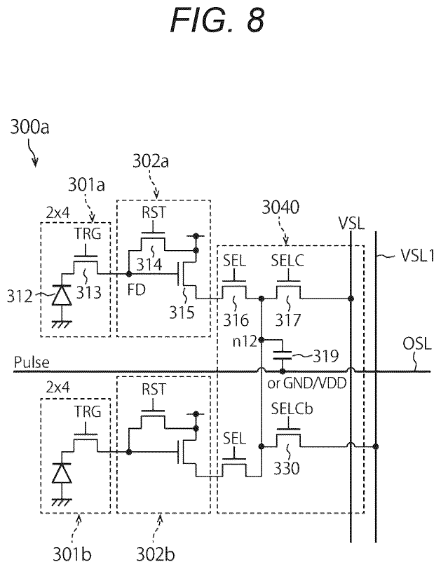

FIG. 8 is a circuit diagram illustrating a configuration example of a pixel circuit 300a according to the second embodiment. As illustrated in FIG. 8, the pixel circuit 300a according to the present embodiment is different from the pixel circuit 300 according to the first embodiment in that an arithmetic circuit 3040 further includes a second connection transistor 330.

One end of the second connection transistor 330 is connected to a node n12, and the other end is connected to a vertical signal line VSL1. A control line of a vertical drive unit 12 is connected to a gate of the second connection transistor 330, and a signal SELCb is supplied thereto. The second connection transistor 330 is in a conductive state when the signal SELCb is at a high level, and is in a non-conductive state when the signal SELCb is at a low level. Note that a selection connection transistor 317 according to the present embodiment corresponds to a third switching element. A parasitic capacitance Cvsl of the vertical signal line VSL1 has a value equivalent to, for example, the parasitic capacitance Cvsl of the vertical signal line VSL.

As described above, in a case where the connection transistor 317 is brought into the conductive state, analog operation using the parasitic capacitance Cvsl of the vertical signal line VSL can be performed according to the expressions (1) and (2). Meanwhile, in a case where the second connection transistor 330 is brought into the conductive state, analog operation using the parasitic capacitance Cvsl of the vertical signal line VSL1 can be performed according to the expressions (1) and (2). Thereby, the vertical signal line VSL can be used for, for example, an arithmetic operation for a positive arithmetic coefficient, and the vertical signal line VSL1 can be used for, for example, an arithmetic operation for a negative arithmetic coefficient. As a result, a signal processing circuit 16 can process a digital image signal corresponding to the vertical signal line VSL as an arithmetic result of the positive coefficient and process the digital image signal corresponding to the vertical signal line VSL1 as an arithmetic result of the negative coefficient.

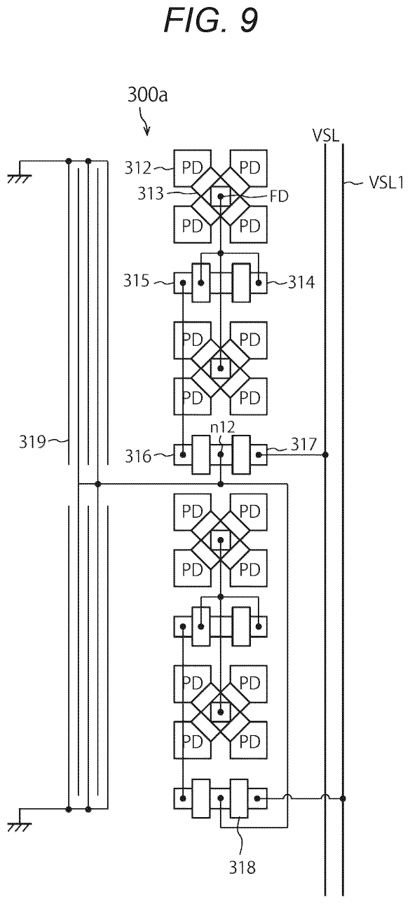

FIG. 9 is a diagram illustrating a layout of the pixel circuit 300a. As illustrated in FIG. 9, a capacitance 319 is configured by metal/insulating film/metal capacitance (metal-insulator-metal (MIM)). The capacitance 319 may be configured in the same layer as a pixel 111. Alternatively, the capacitance 319 may be configured in a layer different from that of the pixel 111.

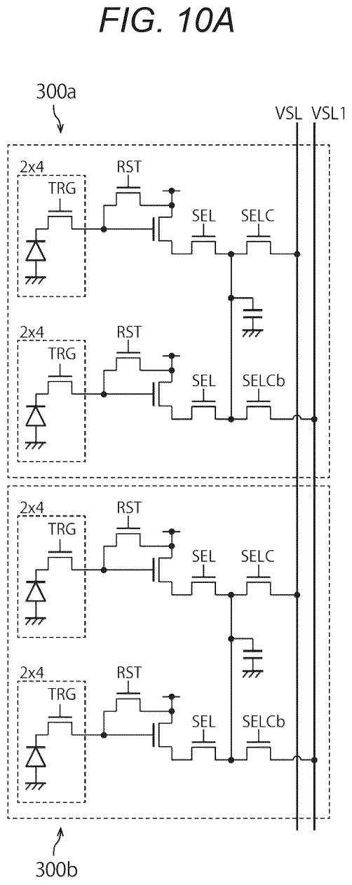

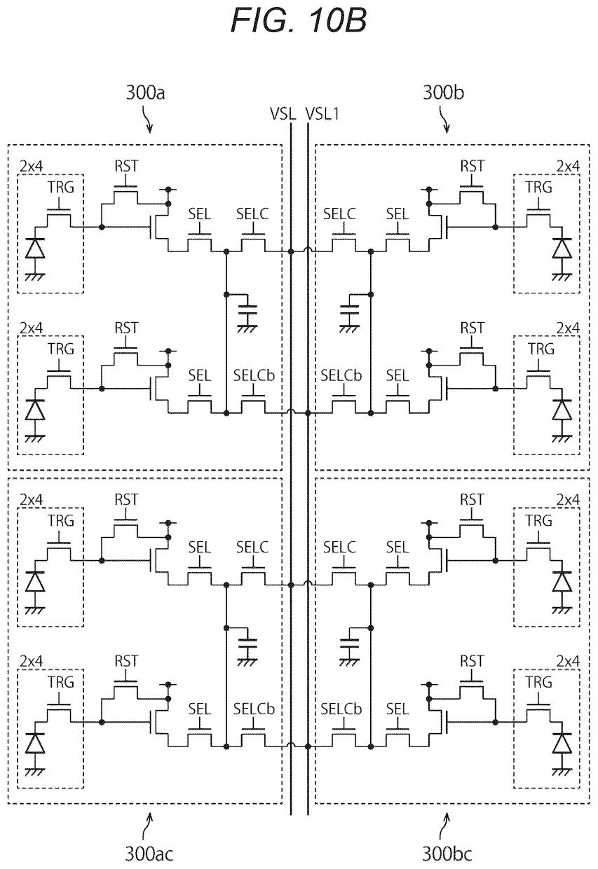

FIG. 10A is a diagram illustrating a connection example of two pixel circuits 300a and 300b to the vertical signal line VSL and the vertical signal line VSL1. FIG. 10B is a diagram illustrating a connection example to the vertical signal line VSL and the vertical signal line VSL1 in a case where the two pixel circuits 300a and 300b are arranged in a horizontal direction. Here, the pixel circuit 300a and the pixel circuit 300b have an equivalent configuration. Furthermore, the two pixel circuits 300a and 300b and two pixel circuits 300ac and 300bc have an equivalent configuration, but can be independently driven.

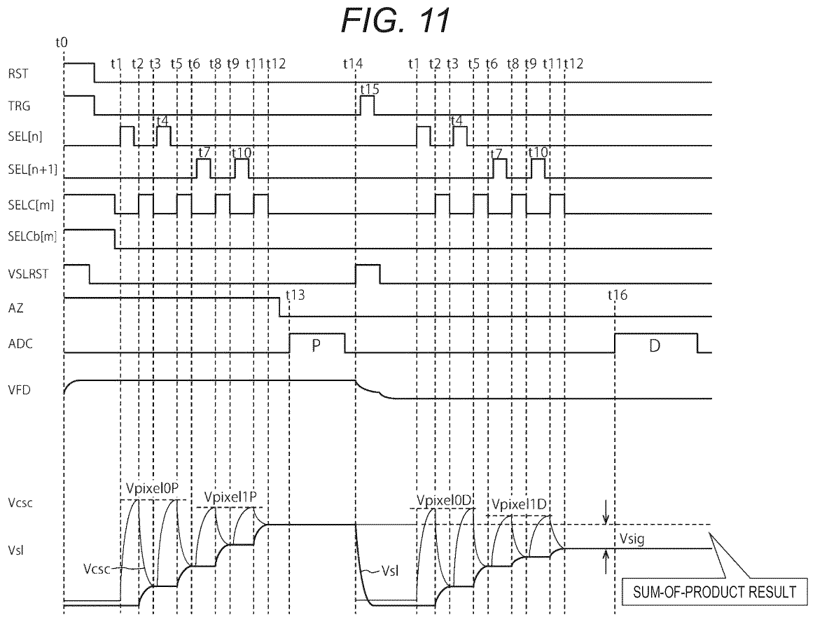

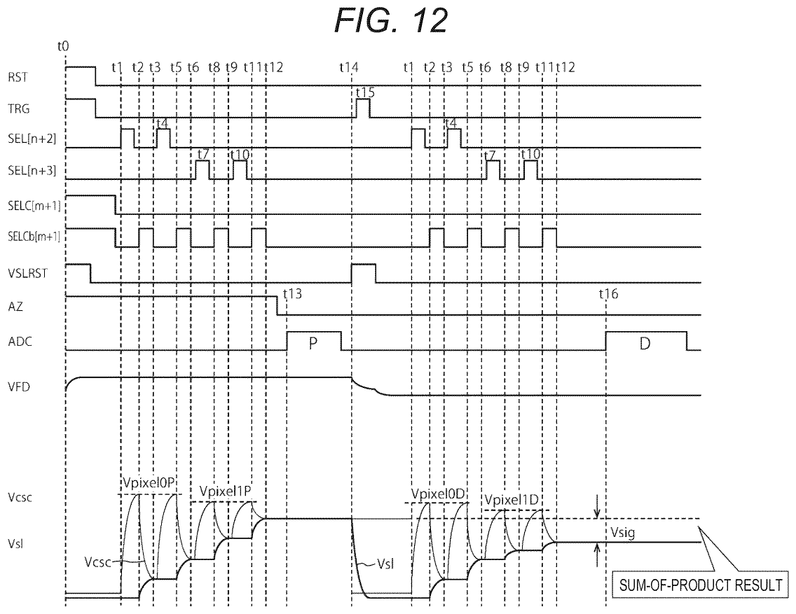

FIG. 11 is a time chart illustrating an operation example of the upper photoelectric conversion circuit 301a illustrated in FIG. 10A. FIG. 12 is a time chart illustrating an operation example of the lower photoelectric conversion circuit 301b illustrated in FIG. 10A.

In FIGS. 11 and 12, SEL[n], SEL[n+1], SEL[n+2], and SEL[n+3] are attached to a signal SEL of FIG. 10A in order from the top. Similarly, SELC[m] and SELC[m+1] are attached to a signal SELC in order from the top, and SELCb[m] and SELCb[m+1] are attached to the signal SELCb in order from the top. FIG. 11 illustrates an example of performing positive coefficient operation using the upper photoelectric conversion circuit 301a. FIG. 12 illustrates an example of performing negative coefficient operation using the lower photoelectric conversion circuit 301b.

As illustrated in FIG. 11, the signal SELCb[m] is in the non-conductive state after timing t1. The subsequent operation is similar to the processing operation illustrated in FIG. 7. That is, an analog operation for the positive arithmetic coefficient using the parasitic capacitance Cvsl of the vertical signal line VSL is executed.

Meanwhile, as illustrated in FIG. 12, the signal SELC[m+1] is in the non-conductive state after timing t1. The subsequent operation is similar to the processing operation illustrated in FIG. 7. That is, an analog operation for the negative arithmetic coefficient using the parasitic capacitance Cvsl of the vertical signal line VSL1 is executed.

As described above, according to the present embodiment, the arithmetic circuit 3040 further includes the second connection transistor 330 having one end connected to the node n12 and the other end connected to the vertical signal line VSL1 different from the vertical signal line VSL. Thereby, the analog operation using the vertical signal line VSL1 can be performed. Therefore, it is possible to perform the analog operation for the positive arithmetic coefficient using the vertical signal line VSL and perform the analog operation for the negative arithmetic coefficient using the vertical signal line VSL1.

### Modification 1 of Second Embodiment

The imaging device 100 according to Modification 1 of the second embodiment is different from the imaging device 100 according to the second embodiment in that the capacitances 319 of a plurality of pixel circuits are connected in parallel. Differences from the imaging device 100 according to the second embodiment will be described below.

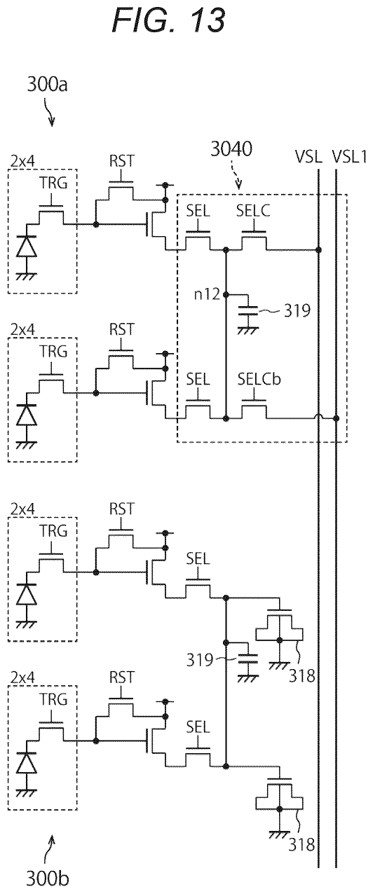

FIG. 13 is a circuit diagram illustrating a configuration example of pixel circuits 300a and 3000b according to Modification 1 of the second embodiment. As illustrated in FIG. 13, the capacitance 319 of the pixel circuit 3000b according to the present embodiment is connected to the node n12 of the pixel circuit 300a. Furthermore, the pixel circuit 3000b is different from the pixel circuit 300b illustrated in FIG. 8 in that the connection transistor 317 and the second connection transistor 330 are used as a capacitance element 318 (MOS-cap).

As a result, the arithmetic operation using the reset potential and the photoelectric conversion potential of the floating diffusion FD of each pixel circuit 3000b can be performed using the arithmetic circuit 3040 of the pixel circuit 300a, and the photoelectric conversion element 200 can be further miniaturized. Furthermore, the plurality of capacitances 319 and the plurality of capacitance elements 318 can be connected in parallel, and the capacitance can be increased.

Furthermore, by arranging the connection transistor 317 and the second connection transistor 330 as the capacitance element 318, it is possible to balance arrangement of the transistors corresponding to the pixel circuit 300a and arrangement of the transistors corresponding to the pixel circuit 3000b. For example, by balancing the arrangement, it is possible to harmonize the parasitic capacitance corresponding to the pixel circuit 300a and the parasitic capacitance corresponding to the pixel circuit 3000b, and to suppress generation of a unique potential distribution.

### Modification 2 of Second Embodiment

The imaging device 100 according to Modification 1 of the second embodiment is different from the imaging device 100 according to the second embodiment in that the capacitances 319 of a plurality of pixel circuits are connected in parallel and the number of transistors is reduced. Differences from the imaging device 100 according to the second embodiment will be described below.

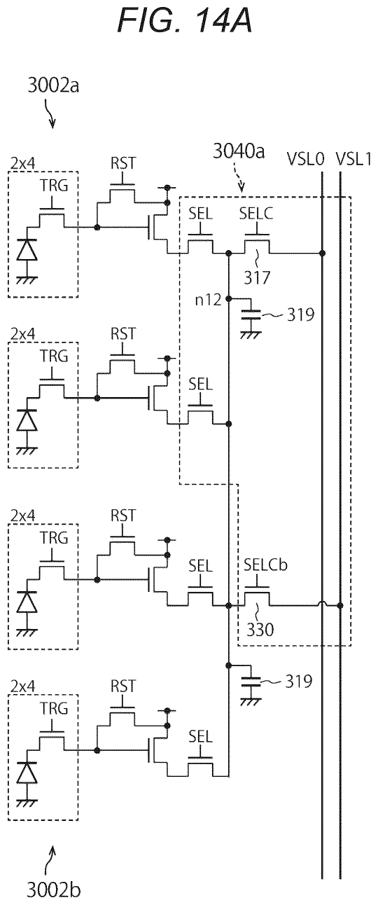

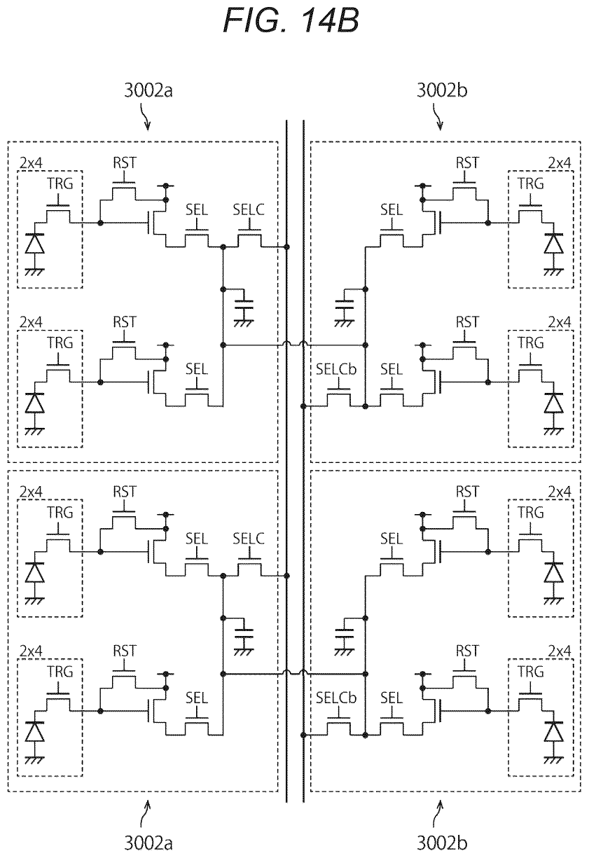

FIG. 14A is a circuit diagram illustrating a configuration example of pixel circuits 3002a and 3002b according to Modification 2 of the second embodiment. As illustrated in FIG. 14A, the capacitance 319 of the pixel circuit 3002b according to the present embodiment is connected to the node n12 of the pixel circuit 3002a. Furthermore, the pixel circuit 3002a does not include the second connection transistor 330, and uses the second connection transistor 330 of the pixel circuit 3002b. On the other hand, the pixel circuit 3002b does not include the connection transistor 317, and uses the connection transistor 317 of the pixel circuit 3002a.

Thereby, the arithmetic operation using the reset potential and the photoelectric conversion potential of the floating diffusion FD of each of the pixel circuits 3002a and 3002 can be performed using an arithmetic circuit 3040a using the connection transistor 317 of the pixel circuit 3002a and the second connection transistor 330 of the pixel circuit 3002b, and the photoelectric conversion element 200 can be further miniaturized. Furthermore, the plurality of capacitances 319 and capacitance elements 318 can be connected in parallel, and the capacitance can be increased.

Furthermore, the arithmetic circuit 3040a is configured using the connection transistor 317 of the pixel circuit 3002a and the second connection transistor 330 of the pixel circuit 3002b, and can balance arrangement of the transistors corresponding to the pixel circuit 3002a and arrangement of the transistors corresponding to the pixel circuit 3002b. For example, by balancing the arrangement, it is possible to harmonize the parasitic capacitance corresponding to the pixel circuit 3002a and the parasitic capacitance corresponding to the pixel circuit 3002b, and to suppress generation of a unique potential distribution.

FIG. 14B is a diagram in which the arrangement example of FIG. 14A is changed from the vertical direction to the horizontal direction. As illustrated in FIG. 14B, the pixel circuits 3002a and 3002b according to Modification 2 of the second embodiment can be arranged side by side in the horizontal direction. Also in this case, it is possible to obtain similar effects to those of the pixel circuits 3002a and 3002b in FIG. 14A.

### Third Embodiment

An imaging device 100 according to a third embodiment is different from the imaging device 100 according to the first embodiment in that a readout circuit 3020 can switch a capacitance in two stages. Differences from the imaging device 100 according to the first embodiment will be described below.

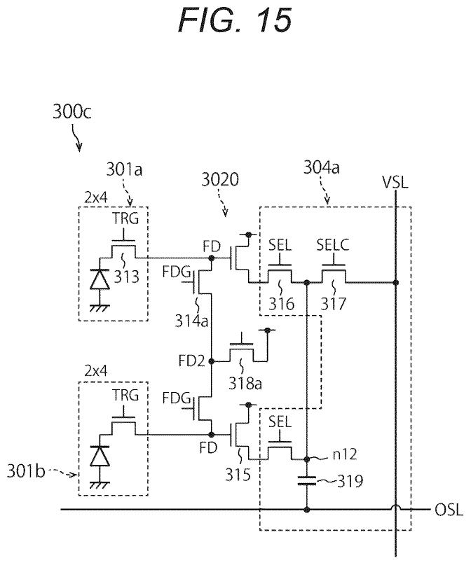

FIG. 15 is a circuit diagram illustrating a configuration example of a pixel circuit 300c according to the third embodiment. As illustrated in FIG. 13, the readout circuit 3020 of a pixel circuit 300c according to the present embodiment is configured to be suppliable by photoelectric conversion circuits 301a and 301b. The readout circuit 3020 includes two connection transistors 314a, two amplification transistors 316, a second reset transistor 318a, and a second floating diffusion FD2.

One ends of the two connection transistors 314a are connected to the respective floating diffusions FD, and the other ends are connected to the second floating diffusion FD2. A control line of a vertical drive unit 12 is connected to a gate, and a signal TRG is supplied thereto. The two connection transistors 314a are in a conductive state when the signal FDG is at a high level, and are in a non-conductive state when the signal FDG is at a low level. The second reset transistor 318a has one end connected to the second floating diffusion FD2 and the other end connected to a power line VDD.

### (Shared Mode)

The readout circuit 3020 can use the two connection transistors 314a in a shared mode as the conductive state. In a case of being used in the shared mode, capacitances of the second floating diffusion FD2 and the two floating diffusions FD are shared by the photoelectric conversion circuits 301a and 301b. Reset potentials of the second floating diffusion FD2 and the two floating diffusions FD can be obtained by bringing the second reset transistor 318a into the conductive state for a predetermined period. Furthermore, the number of transistors included in the pixel circuit 300c according to the third embodiment and the number of transistors included in the pixel circuit 300 according to the first embodiment can be the same.

Furthermore, a photoelectric conversion potential can be obtained by bringing the second reset transistor 318a into the conductive state for a predetermined period and then bringing transfer transistors 313 of the photoelectric conversion circuits 301a and 301b into the non-conductive state.

### (Independent Mode)

The readout circuit 3020 can use the two connection transistors 314a in an independent mode as the non-conductive state. In the independent mode, one floating diffusion FD is used by the photoelectric conversion circuit 301a, and the other floating diffusion FD is used by the photoelectric conversion circuit 301b.

The respective reset potentials of the two floating diffusions FD can be obtained by bringing the two connection transistors 314a into the conductive state, bringing the second reset transistor 318a into the conductive state for a predetermined period, and then bringing the two connection transistors 314a and the second reset transistor 318a into the non-conductive state. Furthermore, the photoelectric conversion potential of one floating diffusion FD can be obtained by bringing the transfer transistor 313 of the photoelectric conversion circuit 301a into the conductive state. Similarly, the photoelectric conversion potential of the other floating diffusion FD can be obtained by bringing the transfer transistor 313 of the photoelectric conversion circuit 301b into the conductive state.

As described above, in a case where the pixel circuit 300c according to the third embodiment shares the second floating diffusion FD2 and the two floating diffusions FD, it is possible to simultaneously obtain the photoelectric conversion potentials of the photoelectric conversion circuits 301a and 301b in the shared mode. Furthermore, in a case where the second floating diffusion FD2 and the two floating diffusions FD are not shared, one floating diffusion FD can be used by the photoelectric conversion circuit 301a, and the other floating diffusion FD can be used by the photoelectric conversion circuit 301b in the independent mode.

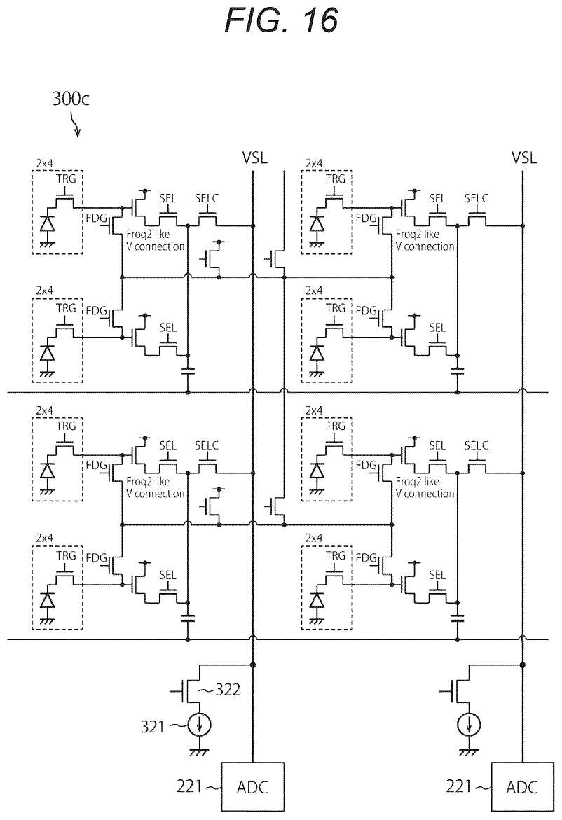

FIG. 16 is a diagram illustrating an example in which the pixel circuits 300c according to the third embodiment are two-dimensionally arranged. As illustrated in FIG. 16, the pixel circuits 300c are two-dimensionally arranged. In FIG. 16, the pixel circuits 300c are configured in 2×2, but the embodiment is not limited thereto. For example, the pixel circuits 300c can be arranged with an order of several thousands×several thousands.

### Fourth Embodiment

An imaging device 100 according to a fourth embodiment is different from the imaging device 100 according to the second embodiment in that an output signal of an arithmetic circuit can be selectively output to a vertical signal line VSL and a horizontal signal line HSL. Differences from the imaging device 100 according to the second embodiment will be described below.

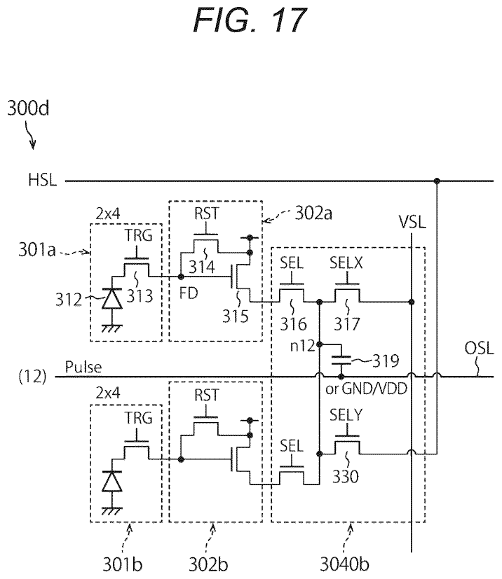

FIG. 17 is a circuit diagram illustrating a configuration example of a pixel circuit 300d according to the fourth embodiment. As illustrated in FIG. 17, an arithmetic circuit 3040b of the pixel circuit 300c according to the present embodiment is different from the pixel circuit 300a according to the second embodiment illustrated in FIG. 8 in that one end of a second connection transistor 330 is connected to a node n12 and the other end is connected to the horizontal signal line HSL. That is, a control line of a vertical drive unit 12 is connected to a gate of the second connection transistor 330, and a signal SELY is supplied thereto. The second connection transistor 330 is in a conductive state when the signal SELY is at a high level, and is in a non-conductive state when the signal SELY is at a low level. Furthermore, a parasitic capacitance Cvsl of the horizontal signal line VSL1 has a value equivalent to, for example, the parasitic capacitance Cvsl of the vertical signal line VSL.

Furthermore, the control line of the vertical drive unit 12 is connected to a gate of a first connection transistor 317, and a signal SELX is supplied thereto. In the first connection transistor 317, when the signal SELX is at the high level, the parasitic capacitance Cvsl of the horizontal signal line VSL1 has a value equivalent to the parasitic capacitance Cvsl of the vertical signal line VSL, for example.

With such a configuration, a readout direction of the pixel circuit 300d can be either a vertical direction or a horizontal direction, or both the vertical and horizontal directions.

### Fifth Embodiment

An imaging device 100 according to a fifth embodiment is different from the imaging device 100 according to the first embodiment in that an output signal of a pixel circuit 300 can be output to a vertical signal line VSL via a third connection transistor 340. Differences from the imaging device 100 according to the second embodiment will be described below.

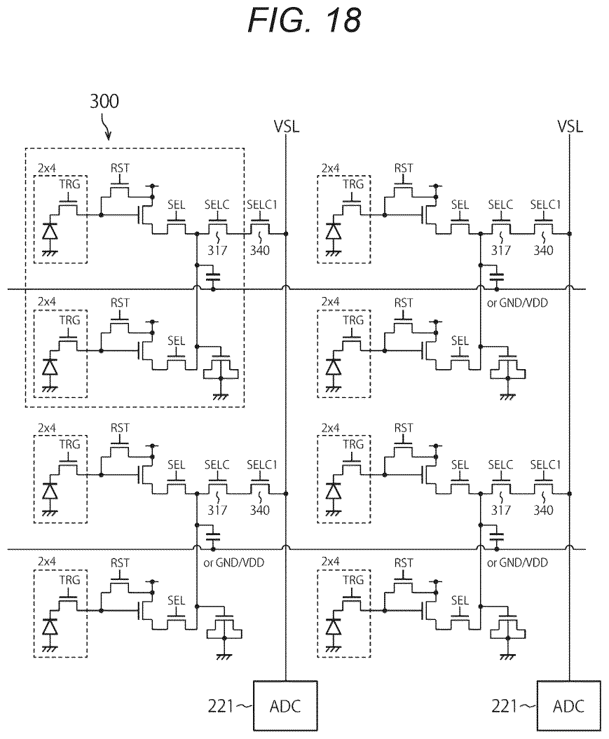

FIG. 18 is a circuit diagram illustrating a configuration example of the pixel circuit 300 according to the fifth embodiment. As illustrated in FIG. 18, the pixel circuit 300 according to the present embodiment is connected to the vertical signal line VSL via the third connection transistor 340. That is, the third connection transistor 340 is different from the pixel circuit 300 according to the first embodiment illustrated in FIG. 4A in that one end is connected to the other end of a first connection transistor 317 and the other end is connected to the vertical signal line VSL.

That is, a control line of a vertical drive unit 12 is connected to a gate of the third connection transistor 340, and a signal SELC1 is supplied thereto. The third connection transistor 340 is in a conductive state when the signal SELC1 is at a high level, and is in a non-conductive state when the signal SELC1 is at a low level. Note that the third connection transistor 340 according to the present embodiment corresponds to a fourth switching element.

With such a configuration, connection elements can be divided into two by the first connection transistor 317 and the third connection transistor 340. Thus, for example, the first connection transistor 317 can be controlled from horizonal wiring, and the SELC1 can be controlled from vertical wiring. Furthermore, control of the conductive state or the non-conductive state of the third connection transistor 340 can be performed by a two-dimensional XY address.

### Sixth Embodiment

An imaging device 100 according to a sixth embodiment is different from the imaging devices 100 according to the first to fifth embodiments in that a photoelectric conversion element is configured by an element having an organic or inorganic photoelectric conversion film. Differences from the imaging devices 100 according to the first to fifth embodiments will be described below.

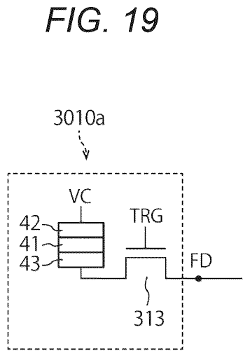

FIG. 19 is a diagram illustrating a configuration example of a photoelectric conversion circuit 3010a according to the sixth embodiment. As illustrated in FIG. 19, the photoelectric conversion circuit 3010a according to the present embodiment includes a photoelectric conversion film 41, a transparent electrode 42, a lower electrode 43, and a reset transistor 313. Note that, in the photoelectric conversion circuit 3010a including the photoelectric conversion film 41, for example, the photoelectric conversion film 41 controls a voltage of the transparent electrode 42, thereby implementing a global shutter (see Patent Document 2).

In the case of the circuit configuration of FIG. 19, start and end of VC input to the transparent electrode 42 are controlled by controlling the voltage of the transparent electrode 42 by a vertical drive unit 12.

### Seventh Embodiment

An imaging device 100 according to a seventh embodiment is different from the imaging devices 100 according to the first to fifth embodiments in that a capacitance corresponding to a photoelectric conversion element 312 is added in a changeable manner. Differences from the imaging devices 100 according to the first to fifth embodiments will be described below.

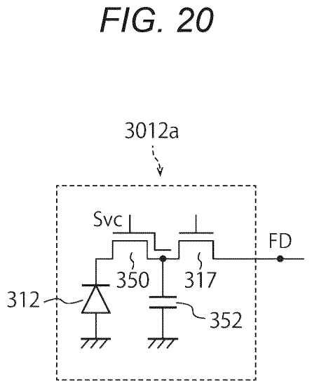

FIG. 20 is a diagram illustrating a configuration example of a photoelectric conversion circuit 3012a according to the seventh embodiment. As illustrated in FIG. 20, the photoelectric conversion circuit 3012a according to the present embodiment is different from the photoelectric conversion circuit 301a in further including a capacitance adjustment transistor 350 and a capacitance 352.

One end of the capacitance adjustment transistor 350 is connected to a cathode of the photoelectric conversion element 312, and the other end is connected to one end of a transfer transistor 313. Furthermore, the other end of the capacitance adjustment transistor 350 is connected to the capacitance 352.

Furthermore, a control line of a vertical drive unit 12 is connected to a gate of the capacitance adjustment transistor 350, and a signal Svc is supplied thereto. The capacitance adjustment transistor 350 implements a global shutter function by operating all of pixels at the same time.

### Eighth Embodiment

An imaging device 100 according to an eighth embodiment is different from the imaging devices 100 according to the first to fifth embodiments in that a photoelectric conversion circuit 3014a further includes a logarithmic conversion circuit 360. Differences from the imaging devices 100 according to the first to fifth embodiments will be described below.

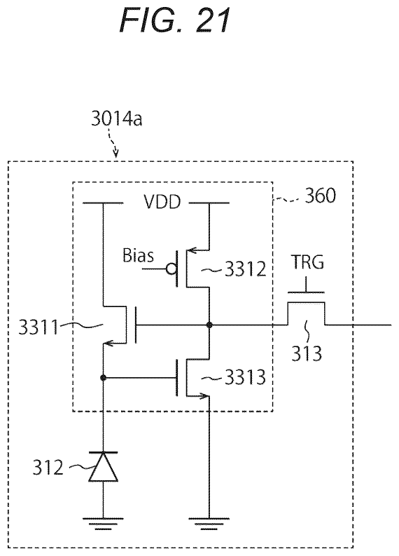

FIG. 21 is a diagram illustrating a configuration example of the photoelectric conversion circuit 3014a according to the eighth embodiment. As illustrated in FIG. 21, the photoelectric conversion circuit 3014a according to the present embodiment is different from the photoelectric conversion circuit 301a in further including the logarithmic conversion circuit 360.

The logarithmic conversion circuit 360 has a circuit configuration including, for example, a transistor 3311, a transistor 3312, and a transistor 3313. For example, the transistor 3311 is an N-type MOS transistor, the transistor 3312 is a P-type MOS transistor, and the transistor 3313 is an N-type MOS transistor.

The N-type transistor 3311 is connected between a power line of a supply voltage VDD and a cathode of a photoelectric conversion element 312. The P-type transistor 3312 and the N-type transistor 3313 are connected in series between the power line of the supply voltage VDD and a ground. Then, a gate electrode of the N-type transistor 3311 is connected to a common connection node of the P-type transistor 3312 and the N-type transistor 3313.

A predetermined bias voltage Bias is applied to the gate electrode of the P-type transistor 3312. As a result, the P-type transistor 3312 supplies a constant current to the N-type transistor 3313. The photocurrent is input from the photoelectric conversion element 312 to a gate electrode of the N-type transistor 3313.

A source of the N-type transistor 3311 is installed to constitute a ground amplifier, and a drain electrode of the N-type transistor 3313 is connected to a power supply side to constitute a source follower. By these two circuits connected in a loop shape, the photocurrent from the photoelectric conversion element 312 is converted into a logarithmic voltage signal Vlog and supplied to one end of a transfer transistor. Such a logarithmic conversion circuit 360 converts the photocurrent flowing through the photoelectric conversion element 312 into a voltage. In this case, by performing logarithmic compression, for example, it is possible to support a wider illuminance range.

### Ninth Embodiment

An imaging device 100 according to a ninth embodiment is different from the imaging device 100 according to the first embodiment in that a readout circuit 3020a is amplified by a source installation circuit. Differences from the imaging device 100 according to the first embodiment will be described below.

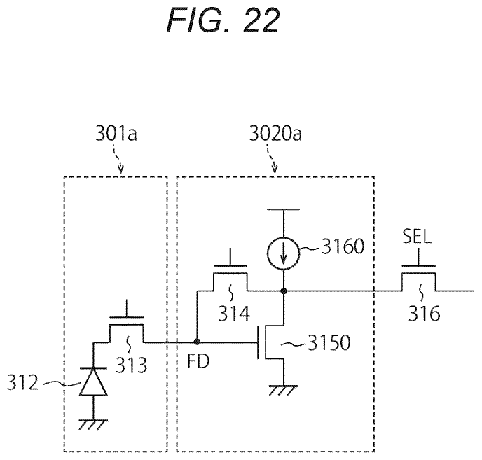

FIG. 22 is a diagram illustrating a configuration example of the readout circuit 3020a according to the ninth embodiment. As illustrated in FIG. 22, the readout circuit 3020a according to the present embodiment includes a reset transistor 314, a current source 3160, and an amplification transistor 3150.

A floating diffusion FD is connected to a gate of the amplification transistor 3150. Furthermore, one end of the amplification transistor 3150 is connected to the current source 3160, and the other end is connected to a ground. With such a configuration, a potential of the floating diffusion FD is amplified and supplied to a selection transistor 316. In this manner, it is possible to perform amplification by the source installation circuit.

### Tenth Embodiment

An imaging device 100 according to a tenth embodiment is different from the imaging device 100 according to the second embodiment in that a readout circuit 3020b can store a reset potential and a photoelectric conversion potential. Differences from the imaging device 100 according to the second embodiment will be described below.

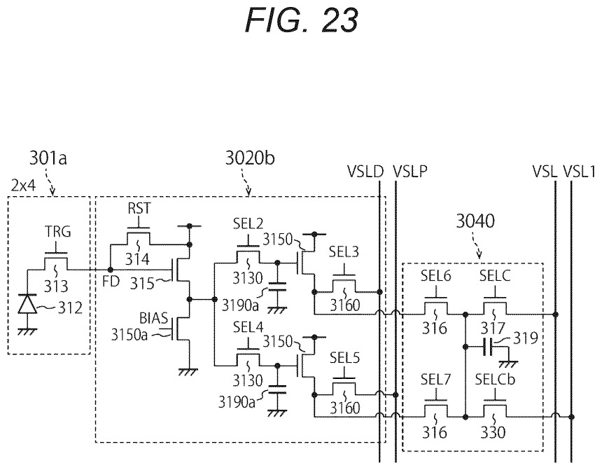

FIG. 23 is a diagram illustrating a configuration example of the readout circuit 3020b according to the tenth embodiment. As illustrated in FIG. 23, the readout circuit 3020b according to the present embodiment includes a reset transistor 314, an amplification transistor 315, an amplification factor adjustment transistor 3150a, two third selection transistors 3130, two capacitances 3190a, two second amplification transistors 3150, and two fourth selection transistors 3130.

A reset potential of a floating diffusion FD is applied to an upper capacitance 3190a when signals SEL2 and SEL3 are at a high level. Meanwhile, a photoelectric conversion potential of the floating diffusion FD is applied to a lower capacitance 3190a when signals SEL5 and SEL7 are at a high level.

As can be seen from these configurations, by repetition of high-level signals of signals SEL6 and SELC, an arithmetic result corresponding to a positive coefficient of the reset potential is read to a vertical signal line VSL. Subsequently, by repetition of high-level signals of signals SEL7 and SELC, an arithmetic result corresponding to a positive coefficient of the photoelectric conversion potential is read to the vertical signal line VSL.

Similarly, by repetition of high-level signals of signals SEL7 and SELCb, an arithmetic result corresponding to a negative coefficient of the reset potential is read to a vertical signal line VSL1. Similarly, by repetition of the high-level signals of the signals SEL7 and SELCb, an arithmetic result corresponding to a negative coefficient of the photoelectric conversion potential is read to the vertical signal line VSL1.

Furthermore, the reset potential is read to a vertical signal line VSLD by the high-level signal of the signal SEL3. Similarly, the photoelectric conversion potential is read to a vertical signal line VSLP by the high-level signal of the signal SEL5. As described above, the arithmetic circuit 3040 can perform analog operation for both the positive and negative coefficients.

Note that the present technology may have the following configurations.

(1)

An optical element including:
a pixel including a photoelectric conversion element that photoelectrically converts incident light;
a readout circuit having a first capacitance capable of maintaining a potential according to a charge generated by the photoelectric conversion; and
an arithmetic circuit capable of changing the number of times of readout of the potential of the first capacitance according to an arithmetic coefficient, in which
the arithmetic circuit reads a reset potential of the first capacitance the number of times, and reads a photoelectric conversion potential of the first capacitance according to the charge generated by the photoelectric conversion the number of times.
   (2)

The optical element according to (1), further including:
a second capacitance connected to a first signal line, in which
the arithmetic circuit includes
a first switching element having one end connected to the first capacitance,
a third capacitance connected to another end of the first switching element, and
a second switching element having one end connected to the third capacitance and another end connected to the first signal line.
   (3)

The optical element according to (2), in which
the arithmetic circuit
repeats driving of bringing the first switching element into a conductive state for a predetermined period, and then bringing the first switching element into a non-conductive state, and bringing the second switching element into a conductive state for a predetermined period the number of times according to the arithmetic coefficient.
   (4)

The optical element according to (3), in which
the number of times includes zero, and
the arithmetic circuit has a first mode of repeating the driving with respect to the reset potential according to the arithmetic coefficient.
   (5)

The optical element according to (4), in which the arithmetic circuit has a second mode of repeating the driving with respect to the photoelectric conversion potential according to the arithmetic coefficient.

(6)

The optical element according to (5), further including: an analog-to-digital converter connected to the first signal line.

(7)

The optical element according to (6), in which the analog-to-digital converter generates a digital image signal according to the arithmetic coefficient on the basis of a first numerical value according to a potential of the first signal line in the first mode and a second numerical value according to a potential of the first signal line in the second mode.

(8)

The optical element according to (2), further including:
a plurality of the readout circuits, in which
the first capacitance of each of the plurality of readout circuits is connected to the one end of the first switching element.
   (9)

The optical element according to (8), in which
each of the readout circuits includes the corresponding pixel, and
the pixel further includes
a transfer transistor having one end connected to a cathode of the photoelectric conversion element and another end connected to the first capacitance of the corresponding readout circuit.
   (10)

The optical element according to (9), in which each of the readout circuits includes a plurality of the corresponding pixels.

(11)

The optical element according to (2), further including:
a control circuit, in which
the pixel includes
a transfer transistor having a gate connected to a control line of the control circuit, one end connected to a cathode of the photoelectric conversion element, and another end connected to the first capacitance of the corresponding readout circuit, and
the readout circuit includes
a reset transistor having a gate connected to the control line of the control circuit, one end connected to the first capacitance, and another end connected to a predetermined potential, and
an amplification transistor having a gate connected to the first capacitance and another end connected to one end of the first switching element.
   (12)

The optical element according to (11), in which the control circuit brings the reset transistor into a conductive state for a predetermined time and then brings the reset transistor into a non-conductive state, and brings the transfer transistor into a non-conductive state to generate the reset potential.

(13)

The optical element according to (11), in which the control circuit brings the transfer transistor into a conductive state for a predetermined time and brings the reset transistor into a conductive state for a predetermined time, then brings the transfer transistor and the reset transistor into a non-conductive state, and brings the transfer transistor into a conductive state for a predetermined time after a lapse of a predetermined time to generate the photoelectric conversion potential.

(14)

The optical element according to (2), further including:
a second capacitance connected to a second signal line, in which
the second signal line is a signal line arranged in a first direction or a signal line arranged in a second direction different from the first direction, and
the arithmetic circuit further includes
a third switching element having one end connected to the second capacitance and another end connected to the second signal line.
   (15)

The optical element according to (2), in which the third capacitance has at least one of an interwiring capacitance (metal-oxide-metal (MOM)), a metal/insulating film/metal capacitance (metal-insulator-metal (MIM)), or an element capacitance (MOS-cap).

(16)

The optical element according to (2), further including: a fourth switching element, in which the second switching element has another end connected to the first signal line via the fourth switching element.

(17)

The optical element according to (16), in which control of a conductive state or a non-conductive state of the fourth switching element is controllable by a two-dimensional XY address.

(18)

The optical element according to (1), in which
the pixel further includes
a log conversion circuit that is connected to the photoelectric conversion element and nonlinearly converts the potential according to the photoelectric conversion of the photoelectric conversion element, and
the photoelectric conversion potential of the first capacitance is a potential via the log conversion circuit.
   (19)

An arithmetic method for an optical element including
a pixel including a photoelectric conversion element that photoelectrically converts incident light,
a readout circuit having a first capacitance capable of maintaining a potential according to a charge generated by the photoelectric conversion,
an arithmetic circuit capable of performing an arithmetic operation according to a number of times of readout of the potential of the first capacitance, and
a second capacitance connected to a first signal line, and
the arithmetic circuit including
a first switching element having one end connected to the first capacitance,
a third capacitance connected to another end of the first switching element, and
a second switching element having one end connected to the third capacitance and another end connected to the first signal line,
the arithmetic method including:
repeating, according to an arithmetic coefficient, driving of bringing the first switching element into a conductive state for a predetermined period and then bringing the first switching element into a non-conductive state, and bringing the second switching element into a conductive state for a predetermined period, with respect to each of a reset potential of the first capacitance and a photoelectric conversion potential of the first capacitance according to the charge generated by the photoelectric conversion.
   (20)

An electronic device including:
the optical element according to (1); and
an optical system that condenses the incident light on the pixel.

### REFERENCE SIGNS LIST

15 Control unit
100 Imaging device
110 Imaging lens
111 Pixel
200 Photodetection element
301a, 301b, 3010a, 3012a, 3014a Photoelectric conversion circuit
302a, 302b, 3020, 3020a, 3020b Readout circuit
304, 304a, 3040, 3040a, 3040b Arithmetic circuit
312 Photoelectric conversion element
316 Selection transistor
317 Connection transistor
317a Capacitance variable transistor
318 Capacitance element
319 Capacitance
Cvsl Capacitance
HSL Horizontal signal line
VSL, VSL1 Vertical signal line

1. An optical element comprising:
a pixel including a photoelectric conversion element that photoelectrically converts incident light;
a readout circuit having a first capacitance capable of maintaining a potential according to a charge generated by the photoelectric conversion; and
an arithmetic circuit capable of changing a number of times of readout of the potential of the first capacitance according to an arithmetic coefficient, wherein
the arithmetic circuit reads a reset potential of the first capacitance the number of times, and reads a photoelectric conversion potential of the first capacitance according to the charge generated by the photoelectric conversion the number of times.

2. The optical element according to claim 1, further comprising:
a second capacitance connected to a first signal line, wherein
the arithmetic circuit includes
a first switching element having one end connected to the first capacitance,
a third capacitance connected to another end of the first switching element, and
a second switching element having one end connected to the third capacitance and another end connected to the first signal line.

3. The optical element according to claim 2, wherein
the arithmetic circuit
repeats driving of bringing the first switching element into a conductive state for a predetermined period, and then bringing the first switching element into a non-conductive state, and bringing the second switching element into a conductive state for a predetermined period the number of times according to the arithmetic coefficient.

4. The optical element according to claim 3, wherein
the number of times includes zero, and
the arithmetic circuit has a first mode of repeating the driving with respect to the reset potential according to the arithmetic coefficient.

5. The optical element according to claim 4, wherein the arithmetic circuit has a second mode of repeating the driving with respect to the photoelectric conversion potential according to the arithmetic coefficient.

6. The optical element according to claim 5, further comprising: an analog-to-digital converter connected to the first signal line.

7. The optical element according to claim 6, wherein the analog-to-digital converter generates a digital image signal according to the arithmetic coefficient on a basis of a first numerical value according to a potential of the first signal line in the first mode and a second numerical value according to a potential of the first signal line in the second mode.

8. The optical element according to claim 2, further comprising:
a plurality of the readout circuits, wherein
the first capacitance of each of the plurality of readout circuits is connected to the one end of the first switching element.

9. The optical element according to claim 8, wherein
each of the readout circuits includes the corresponding pixel, and
the pixel further includes
a transfer transistor having one end connected to a cathode of the photoelectric conversion element and another end connected to the first capacitance of the corresponding readout circuit.

10. The optical element according to claim 9, wherein each of the readout circuits includes a plurality of the corresponding pixels.

11. The optical element according to claim 2, further comprising:
a control circuit, wherein
the pixel includes
a transfer transistor having a gate connected to a control line of the control circuit, one end connected to a cathode of the photoelectric conversion element, and another end connected to the first capacitance of the corresponding readout circuit, and
the readout circuit includes
a reset transistor having a gate connected to the control line of the control circuit, one end connected to the first capacitance, and another end connected to a predetermined potential, and
an amplification transistor having a gate connected to the first capacitance and another end connected to one end of the first switching element.

12. The optical element according to claim 11, wherein the control circuit brings the reset transistor into a conductive state for a predetermined time and then brings the reset transistor into a non-conductive state, and brings the transfer transistor into a non-conductive state to generate the reset potential.

13. The optical element according to claim 11, wherein the control circuit brings the transfer transistor into a conductive state for a predetermined time and brings the reset transistor into a conductive state for a predetermined time, then brings the transfer transistor and the reset transistor into a non-conductive state, and brings the transfer transistor into a conductive state for a predetermined time after a lapse of a predetermined time to generate the photoelectric conversion potential.

14. The optical element according to claim 2, further comprising:
a second capacitance connected to a second signal line, wherein
the second signal line is a signal line arranged in a first direction or a signal line arranged in a second direction different from the first direction, and
the arithmetic circuit further includes
a third switching element having one end connected to the second capacitance and another end connected to the second signal line.

15. The optical element according to claim 2, wherein the third capacitance has at least one of an interwiring capacitance (metal-oxide-metal (MOM)), a metal/insulating film/metal capacitance (metal-insulator-metal (MIM)), or an element capacitance (MOS-cap).

16. The optical element according to claim 2, further comprising: a fourth switching element, wherein the second switching element has another end connected to the first signal line via the fourth switching element.

17. The optical element according to claim 16, wherein control of a conductive state or a non-conductive state of the fourth switching element is controllable by a two-dimensional XY address.

18. The optical element according to claim 1, wherein
the pixel further includes
a log conversion circuit that is connected to the photoelectric conversion element and nonlinearly converts the potential according to the photoelectric conversion of the photoelectric conversion element, and
the photoelectric conversion potential of the first capacitance is a potential via the log conversion circuit.

19. An arithmetic method for an optical element including
a pixel including a photoelectric conversion element that photoelectrically converts incident light,
a readout circuit having a first capacitance capable of maintaining a potential according to a charge generated by the photoelectric conversion,
an arithmetic circuit capable of performing an arithmetic operation according to a number of times of readout of the potential of the first capacitance, and
a second capacitance connected to a first signal line, and
the arithmetic circuit including
a first switching element having one end connected to the first capacitance,
a third capacitance connected to another end of the first switching element, and
a second switching element having one end connected to the third capacitance and another end connected to the first signal line,
the arithmetic method comprising:
repeating, according to an arithmetic coefficient, driving of bringing the first switching element into a conductive state for a predetermined period and then bringing the first switching element into a non-conductive state, and bringing the second switching element into a conductive state for a predetermined period, with respect to each of a reset potential of the first capacitance and a photoelectric conversion potential of the first capacitance according to the charge generated by the photoelectric conversion.

20. An electronic device comprising:
the optical element according to claim 1; and
an optical system that condenses the incident light on the pixel.
